(19) United States
(12) Patent Application Publication
(10) Pub. No.: US 2021/0329252 A1
(43) Pub. Date: Oct. 21, 2021

(54) MOTION INFORMATION ACQUISITION METHOD AND DEVICE FOR VIDEO ENCODING OR DECODING

(71) Applicant: SZ DJI TECHNOLOGY CO., LTD., Shenzhen (CN)

(72) Inventors: Xiaozhen ZHENG, Shenzhen (CN); Shanshe WANG, Shenzhen (CN); Tianliang FU, Shenzhen (CN); Siwei MA, Shenzhen (CN)

(21) Appl. No.: 17/365,874

(22) Filed: Jul. 1, 2021

Related U.S. Application Data
(63) Continuation of application No. PCT/CN2019/070154, filed on Jan. 2, 2019.

(51) Int. Cl. H04N 19/137; H04N 19/119; H04N 19/96; H04N 19/176

(52) U.S. Cl. CPC H04N 19/137; H04N 19/176; H04N 19/96; H04N 19/119

(57) ABSTRACT

A motion information acquisition method for video encoding or decoding includes acquiring a to-be-processed image block, where the to-be-processed image block is divided into coding units using quadtree division and non-quadtree division, determining a motion estimation region of the to-be-processed image block according to division information and size of quadtree division nodes of the to-be-processed image block, and obtaining motion information of a coding unit or decoding unit in the motion estimation region according to the motion estimation region.

### CROSS-REFERENCE TO RELATED APPLICATION

This application is a continuation of International Application No. PCT/CN2019/070154, filed Jan. 2, 2019, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of video encoding/decoding and, more particularly, to a motion information acquisition method and device for video encoding or decoding.

### BACKGROUND

In order to realize parallel encoders, the concept of Motion Estimation Region (MER) is introduced into the coding standard. An image block to be encoded is divided into a plurality of MERs. In each MER, an adjacent block in the same MER as a current block will not be used to construct the Merge candidate list of the current block. In other words, there is no dependency between the image blocks in the same MER when the Merge candidate list is constructed. Therefore, all the image blocks in the same MER can be used to construct the Merge candidate list in parallel, so that parallel coding can be realized in the same MER. In existing standards, the shape of an MER is square.

Generally, video encoding is implemented based on image blocks, and an image block to be encoded is divided into a plurality of image blocks for encoding. In order to flexibly and efficiently represent video contents or objects with different texture details and change in motion in a video scene, it is proposed in the high efficiency video coding (HEVC) standard that an image block to be coded can be divided into a plurality of coding units (CUs) by means of Quadtree (QT). In the new generation of video coding standards currently under development, in addition to QT, non-QT division methods, such as Binary Tree (BT), Ternary Tree (TT), and Extended Quadtree (EQT) are newly introduced. One characteristic of a non-QT division method is that an image block obtained by division can be rectangular or have another non-square shape.

For an image block obtained by a non-QT division method, when MERs in the existing technologies are used for encoding, dependency may exist between image blocks in the same MER during motion estimation, and parallel encoding in the MER cannot be performed.

### SUMMARY

This disclosure provides a motion information acquisition method and device for video encoding or decoding. In the case where a non-quadtree method is used, it can also eliminate the dependency when motion estimation is performed between the image blocks in a same motion estimation region, and hence realize parallel encoding or decoding based on the motion estimation region.

In one aspect, a motion information acquisition method for video encoding or decoding is provided. The method includes acquiring a to-be-processed image block, where the to-be-processed image block is divided into coding units using quadtree division and non-quadtree division, determining a motion estimation region of the to-be-processed image block according to division information and size of quadtree division nodes of the to-be-processed image block, and obtaining motion information of a coding unit or decoding unit in the motion estimation region according to the motion estimation region.

In another aspect, a video processing device is provided. The video processing device includes a first acquisition unit configured to acquire a to-be-processed image block, where the to-be-processed image block is divided into coding units using quadtree division and non-quadtree division, a determination unit configured to determine a motion estimation region of the to-be-processed image block according to division information and size of quadtree division nodes of the to-be-processed image block, and a second acquisition unit configured to obtain motion information of a coding unit or decoding unit in the motion estimation region according to the motion estimation region.

In another aspect, a video processing device is provided. The video processing device includes a memory and a processor. The memory is configured to store instructions. The processor is configured to execute the instructions stored in the memory to perform a method consistent with embodiments of the disclosure.

In another aspect, a chip is provided. The chip includes a processor and a communication interface. The processor is configured to control the communication interface to communicate with an external device, and to perform a method consistent with embodiments of the disclosure.

In another aspect, a computer-readable storage medium is provided, on which a computer program is stored. The computer program, when executed by a computer, causes the computer to perform a method consistent with embodiments of the disclosure.

In another aspect, a computer program product containing instructions is provided. The instructions, when executed by a computer, cause the computer to perform a method consistent with embodiments of the disclosure.

Therefore, according to the solutions provided by the disclosure, a motion estimation region is determined according to the division information and size of the quadtree division node, which includes determining the size of the motion estimation region according to the size of the quadtree division node. As such, the dependency between image blocks in the same motion estimation region during motion estimation can be eliminated, so that parallel encoding or decoding in the motion estimation region can be realized.

### BRIEF DESCRIPTION OF THE DRAWINGS

FIG. 1 is a schematic diagram showing a motion estimation region (MER) consistent with the disclosure.

FIG. 2 is a schematic diagram showing non-QT division methods consistent with the disclosure.

FIG. 3 is a schematic diagram showing how motion estimation dependency cannot be eliminated between image blocks in a same MER.

FIG. 4 is a schematic flow chart of a motion information acquisition method for video encoding or decoding consistent with the disclosure.

FIG. 5 is a schematic block diagram of a video processing device consistent with the disclosure.

FIG. 6 is a schematic block diagram of another video processing device consistent with the disclosure.

### DETAILED DESCRIPTION OF THE EMBODIMENTS

Technical solutions in embodiments of the disclosure will be described below in connection with the drawings. Unless otherwise specified, all technical and scientific terms used in the embodiments of the disclosure have the same meaning as commonly understood by those skilled in the technical field of the present application. Terms used in the disclosure are only for the purpose of describing specific embodiments, and are not intended to limit the scope of the disclosure.

In recent years, due to the increasing popularity of portable devices, handheld devices, and wearable devices, the volume of video content continues to grow. As the form of videos becomes more and more complex, storage and transmission of videos become more and more challenging. In order to reduce the bandwidth occupied by video storage and transmission, usually video data is encoded and compressed at the encoding end, and decoded at the decoding end. The mainstream video encoding framework generally includes processes such as prediction, transformation, quantization, and entropy encoding.

The purpose of prediction is to use predicted block information to remove redundant information of a current to-be-encoded image block. Prediction includes two types: intra-frame prediction (intra prediction) and inter-frame prediction (inter prediction). Intra-frame prediction uses the information of the current frame to obtain predicted block data. For example, intra-frame prediction uses spatial information (information in spatial domain) of the current frame to eliminate redundant information. Inter-frame prediction uses information of a reference frame to obtain the predicted block data. For example, inter-frame prediction can use information of temporal adjacent frames before and after the current frame to eliminate redundant information. A temporal adjacent frame of the current frame refers to a frame that is adjacent to the current frame in time domain. The process of inter-frame prediction includes dividing (partitioning) the to-be-encoded image block into several sub-image-blocks, then for each sub-image-block, searching in the reference frame for an image block that best matches the sub-image-block as the predicted block, subtracting pixel values of the sub-image-block from corresponding pixel values of the predicted block to obtain a residual, and combining the obtained residuals corresponding to various sub-image-block to obtain a residual of the to-be-encoded image block.

The purpose of transformation is to remove redundant information of an image block. For example, a transformation matrix can be used to remove the correlation of the residual of the image block, i.e., to remove the redundant information of the image block, so as to improve the encoding efficiency. A two-dimensional transformation is usually used for data blocks in the image block, i.e., the residual information of the data block is respectively multiplied by a transformation matrix and its transposed matrix, to obtain transformation coefficient.

The purpose of quantization is to obtain quantization coefficient based on the transformation coefficient. For example, the transformation coefficient is quantized according to a quantization parameter to obtain the corresponding quantization coefficient.

The purpose of entropy encoding is to obtain a bitstream by entropy encoding the quantization coefficient.

After the encoding end completes the image encoding, the bitstream obtained by entropy encoding and encoding mode information after encoding, such as intra-frame prediction mode, motion vector information, etc., are stored or sent to the decoding end.

Prediction is an important part in the mainstream video coding framework, and inter-frame prediction is realized through motion compensation. An image frame is divided (partitioned) into equal-sized coding areas, such as coding tree units (CTUs), each of which can have a size of, e.g., 64×64 pixels or 128×128 pixels. Each CTU can be further divided into square or rectangular coding units (CU). For each CU, a reference frame (usually an adjacent reconstructed frame in the time domain) is searched for a block most similar to the CU as the predicted block of the CU. A relative displacement between a current block and a similar block is the motion vector (MV). The process of finding a similar block in the reference frame as the predicted value of the current block is motion compensation.

In current video encoding/decoding standards, the Merge mode is used for motion estimation. The Merge mode includes, by constructing a Merge candidate list, searching for the similar block in the reference frame as the predicted value of the current block. The process of constructing the Merge candidate list introduces dependency between blocks adjacent in the spatial domain (also referred to as “spatially-adjacent blocks”).

In hardware implementation, the motion estimation processes for spatially-adjacent blocks are executed in parallel or at least pipelined to increase throughput. Since the motion estimation method of the Merge mode will cause dependence between spatially-adjacent blocks, this prevents the Merge candidate list of the spatially-adjacent blocks from being constructed in parallel. This is a bottleneck in the design of parallel encoders.

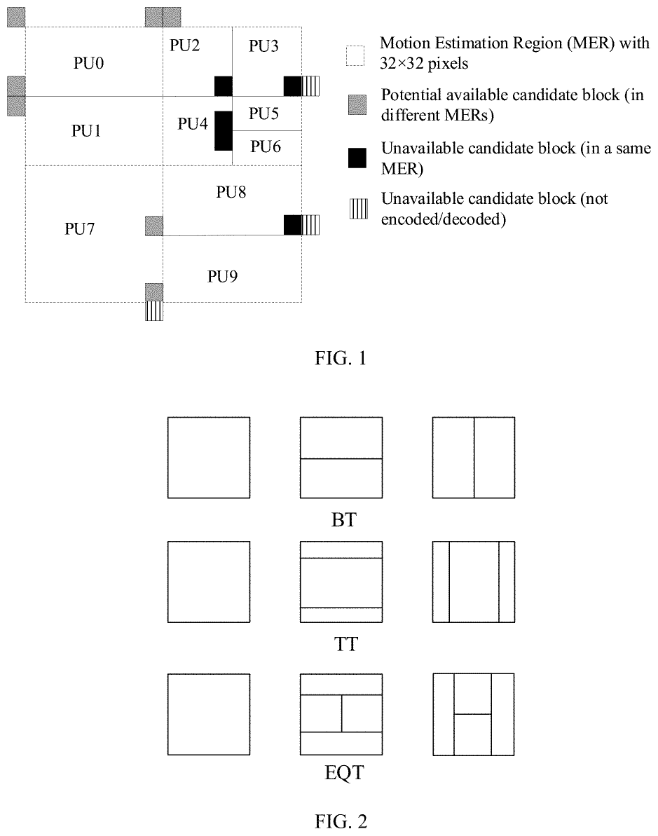

To realize the design of parallel encoder, the concept of motion estimation region (MER) is introduced into the coding standards. A to-be-encoded image block (for example, a CTU) is divided into multiple MERs. In each MER, an adjacent block in the same MER as the current block will not be used to construct the Merge candidate list of the current block. In other words, the motion information of an adjacent block in the same MER as the current block is not used in constructing the Merge candidate list of the current block. That is, there is no dependency between image blocks in the same MER when the Merge candidate list is being constructed. Therefore, Merge candidate lists can be constructed for all the image blocks in the same MER in parallel, and hence parallel coding can be realized in the same MER. As shown in FIG. 1, a to-be-encoded image block is divided into 4 MERs. The first MER includes image blocks PU0 and PU1. All possible Merge candidate blocks of the image block PU0 are available, because these Merge candidate blocks are outside the MER where PU0 is located. The second MER includes image blocks PU2 to PU6. The Merge candidate lists of PU2 to PU6 cannot contain the motion information of PU2 to PU6, to ensure that the motion estimation processes of all image blocks in this MER are independent of each other. It can be seen in FIG. 1 that image block PU5 has no spatially-adjacent Merge candidates available. In the current video standards, MER is square.

Conventional video coding is based on image blocks. Taking into account the characteristics of high-resolution video, the concept of coding tree unit (CTU) is introduced to the video coding standards. The size of a CTU is specified by the encoder. For example, the size of a CTU can be larger than the size of a macro block. In order to flexibly and efficiently represent video contents or video objects with different texture details and change in motion in a video scene, in the high efficiency video coding (HEVC) standard and the digital audio and video encoding and decoding technology standard AVS, a CTU can be directly used as a coding unit (CU), or it can be further divided into a plurality of smaller CUs using quadtree (QT) method. In other words, the size of the CU is variable. Using CUs with a larger size can greatly improve the coding efficiency for a flat area, and using CUs with a smaller size can ensure well processing of local details of the image, thereby allow the prediction of a complex image to be more accurate.

In the new generation of video coding standards currently under development, in addition to QT, other division methods (partitioning methods) such as binary tree (BT), TT, and EQCU are newly introduced for CU division, as shown in FIG. 2. In this disclosure, a division method, such as BT, TT, and EQCU, other than quadtree is also referred to as a non-QT division method. A non-QT division method can allow the CU division to be more flexible, and the more flexible and variable CU division shape can better match the local characteristics of the video.

When both QT and non-QT methods are used for CU division, in the coding process, a CTU is first divided according to the quadtree structure, and then a leaf node of the quadtree is further divided according to the non-QT division method. A leaf node of the non-QT division tree is referred to as a CU.

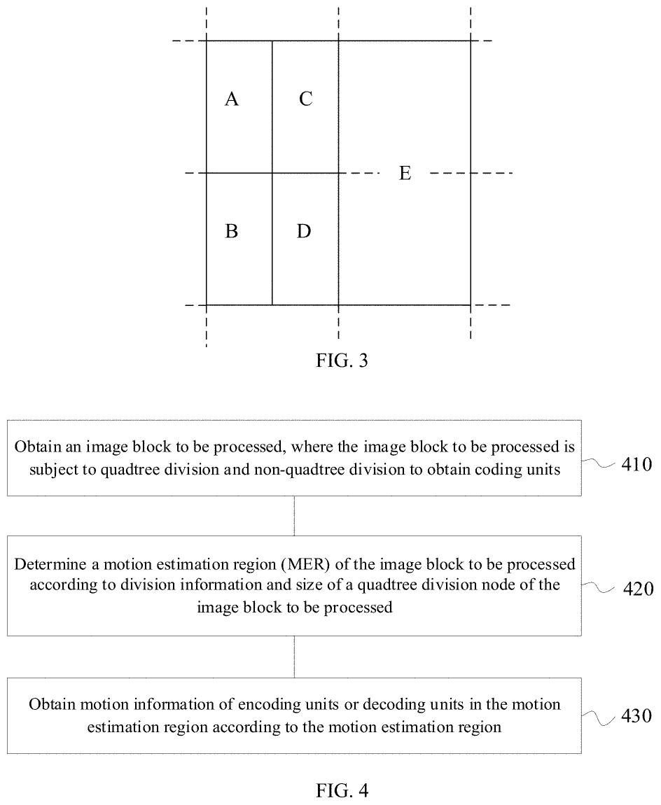

The CU division method can determine the coding order of the image blocks. For example, in FIG. 3, the largest image block undergoes a first non-QT division to obtain left image block 1 (the image block including A, B, C, and D in FIG. 3) and right image block 1 (denoted as E in FIG. 3). Left image block 1 is subject to a second non-QT division to obtain left image block 2 (image block including A and B in FIG. 3) and right image block 2 (image block including C and D in FIG. 3). Left image block 2 and right image block 2 undergo a third non-QT division to obtain image blocks A, B, C, and D. So far, the largest image block shown in FIG. 3 has undergone multiple non-QT divisions to obtain image blocks A, B, C, D, and E. The above-described division method determines that the coding sequence of image blocks A, B, C, D, and E is A→B→C→D→E.

Suppose the largest image block shown in FIG. 3 is divided into 4 MERs (indicated by the dashed lines in FIG. 3), image blocks A and C are located in a same MER, and image blocks B and D are located in a same MER. According to MER design rules, image blocks A and C cannot depend on each other, and image blocks B and D cannot depend on each other, while image blocks A and B can depend on each other, and image blocks B and C can depend on each other. Suppose that during the construction of the Merge candidate list of image block B, image block A is used as the Merge candidate block of image block B, i.e., the coding of image block B depends on the coding of image block A. From the coding sequence A→B→C→D→E, it can be seen that the coding of image block C should depend on the coding of image block A and image block B. Due to the design rules of MER, image blocks A and C cannot depend on each other. Therefore, image block C can only rely on image block B for coding. As described above, the coding of image block B depends on the coding of image block A. It is deduced that the coding of image block C depends on the coding of image block A. In this scenario, the dependency between image block C and image block A cannot be eliminated. Therefore, in the MER that includes image block C and image block A, the parallel motion estimation of image blocks A and B cannot be realized, and consequently parallel coding of image blocks A and B cannot be realized.

As described above in connection with FIG. 3, it can be seen that the non-QT division method may lead to the incapability to achieve parallel coding in MER.

The present disclosure provides a motion information acquisition method for video encoding or decoding. According to the present disclosure, even if a non-QT division method is used, parallel motion estimation in MER can still be effectively realized, thereby realizing parallel coding in MER.

An image block to be encoded (“to-be-encoded image block”) in embodiments of the disclosure can be a coding tree unit (CTU) in the H.265/high efficiency video coding (HEVC) standard, or a macroblock or largest coding unit (LCU) in the H.264/advanced video coding (AVC) standard. The size of the to-be-encoded image block can be 8×8 pixels to 64×64 pixels. The coding unit in the embodiments of the present disclosure can be denoted as CU. For example, in the current encoding/decoding standard, the minimum size of a coding unit is 4×4 pixels.

Further, embodiments of the present disclosure can be applied to an encoder/decoder that complies with an international video encoding/decoding standard such as H.264/advanced video coding (AVC), H.265/HEVC, H.266/versatile video coding (VVC), or a Chinese video coding standard, such as audio video coding standard (AVS).

FIG. 4 shows an example motion information acquisition method 400 for video encoding or decoding. The method 400 can be executed by a video encoder or a video decoder.

At 410, an image block to be processed (also referred to as a “to-be-processed image block” or a “target image block”) is obtained, and the image block to be processed is subject to quadtree division and non-quadtree division to obtain coding units.

The to-be-processed image block can be an image block to be encoded (“to-be-encoded image block”) or an image block to be decoded (“to-be-decoded image block”). The coding unit is also referred to as an “encoding unit” in an encoding process or a “decoding unit” in a decoding process.

For example, an image is to be encoded. The image block to be encoded undergoing quadtree division and non-quadtree division to obtain coding units means that the image block to be coded undergoes quadtree division first and then undergoes non-quadtree division, to obtain coding units. In one example, the root node of the non-quadtree partition is the leaf node of the quadtree partition. The coding unit is, for example, the CU described above.

Quadtree division (partitioning) can also be referred to as QT division (partitioning). Non-quadtree division can also be referred to as non-QT division. The non-QT division can be any of the following division methods: BT, TT, and EQU. Other non-QT division methods can also be used, as long as image blocks obtained by division may include a non-square image block, such a division method is considered to be non-QT division.

At 420, a motion estimation region (MER) of the image block to be processed is determined according to division information and size of a quadtree division node of the image block to be processed.

A quadtree division node in this disclosure can be a leaf node on the quadtree of the image block to be processed, an intermediate node on the quadtree, or a root node on the quadtree, which is not limited here.

For example, the quadtree division node can also be referred to as a current division node of the quadtree.

The size of a quadtree division node refers to the pixel size of the image block corresponding to the division node. For example, the size of the quadtree division node is 16×16 pixels.

The division information of the quadtree division node refers to whether further quadtree division is performed for the quadtree division node, i.e., whether the image block to be processed is further divided according to quadtree method.

For example, when the division information of the quadtree division node is that the image block to be processed is no longer subject to quadtree division, this means that the quadtree division node is a leaf node of the quadtree of the image block to be processed.

As another example, when the division information of the quadtree division node is that the image block to be processed will be subject to further quadtree division, this means that the quadtree division node is an intermediate node of the quadtree of the image block to be processed.

Determining the motion estimation region of the image block to be processed in 420 includes determining a size of the motion estimation region and determining what encoding units or decoding units the motion estimation region covers.

For example, the size of the quadtree division node is used as the size of the motion estimation region. As another example, a positive integer multiple of the size of the quadtree division node can be determined as the size of the motion estimation region.

As another example, it is determined that the motion estimation region covers the coding unit included in the quadtree division node.

At 430, motion information of encoding units or decoding units in the motion estimation region is obtained according to the motion estimation region.

For example, the image block to be processed is an image block to be encoded. In the process of dividing the image block to be encoded according to quadtree division and non-quadtree division, the root node of the non-quadtree is a leaf node of the quadtree. In some embodiments of the disclosure, the motion estimation region is determined according to the size of the quadtree division node. For example, the size of the motion estimation region is set to be equal to the size of the quadtree division node, so that the encoding units under the root node of a same non-quadtree can be ensured to be in a same motion estimation region, and hence the mutual dependency between various image blocks in the same motion estimation region in FIG. 3 during motion estimation can be eliminated. As a result, parallel coding in the motion estimation region can be realized.

Therefore, according to the solutions provided by the disclosure, a motion estimation region is determined according to the division information and size of the quadtree division node, which includes determining the size of the motion estimation region according to the size of the quadtree division node. As such, the dependency between image blocks in the same motion estimation region during motion estimation can be eliminated, so that parallel encoding or decoding in the motion estimation region can be realized.

The solutions provided in this disclosure can be applied to both video encoding and video decoding.

In some embodiments, obtaining the motion information of the encoding units or the decoding units in the motion estimation region according to the motion estimation region (process 430) includes obtaining the motion information of the encoding units or the decoding units in the motion estimation region according to motion information of encoding units or decoding units outside the motion estimation region.

In some embodiments, obtaining the motion information of the encoding units or the decoding units in the motion estimation region according to the motion estimation region (process 430) includes obtaining Merge list information of the encoding units or the decoding units in the motion estimation region according to motion information of encoding units or decoding units outside the motion estimation region.

For example, the Merge list information can be the Merge candidate list described above.

The motion information consistent with the disclosure can include at least one of a motion vector, a motion vector difference, a reference frame index value, whether intra or inter prediction mode is adopted for an encoding or decoding unit, or encoding or decoding unit division information.

In some embodiments, determining the MER of the image block to be processed according to the division information and size of the quadtree division node of the image block to be processed (process 420) includes determining a size of the motion estimation region of the image block to be processed according to the division information and size of the quadtree division node.

For example, the size of the quadtree division node is used as the size of the motion estimation region of the image block to be processed.

Therefore, in some embodiments of the disclosure, the size of the motion estimation region is set to be equal to the size of the quadtree division node of the image block to be processed. Thus, the mutual dependency between various image blocks in the same motion estimation region during motion estimation can be eliminated. As a result, parallel coding in the motion estimation region can be realized.

Various implementations can be used to determine the size of the motion estimation region of the image block to be processed according to the division information and size of the quadtree division node.

In some embodiments, determining the size of the motion estimation region of the image block to be processed includes, when the quadtree division node is a leaf node of the quadtree, using the size of the quadtree division node as the size of the motion estimation region.

In some cases, one or more of the leaf nodes of the quadtree will continue to be further divided via non-quadtree. Each of such one or more leaf nodes is referred to as a root node of a non-quadtree. Other one or more of the leaf nodes of the quadtree may no longer be divided, for example, not further subject to non-quadtree division.

In some embodiments, determining the size of the motion estimation region of the image block to be processed includes, when the quadtree division node is the root node of a non-quadtree, using the size of the quadtree division node as the size of the motion estimation region.

In some embodiments, when the division information of the quadtree division node indicates that the image block to be processed is no longer subject to quadtree division, the size of the quadtree division node is used as the size of the motion estimation region.

In some embodiments, both the encoding end and the decoding end knows the method for determining the size of the motion estimation region. For example, when the encoding end uses the size of the quadtree division node as the size of the motion estimation region, the decoding end also determines the size of the motion estimation region based on this principle.

Therefore, in some embodiments of the disclosure, the size of the motion estimation region is set to be equal to the size of a leaf node of the quadtree. Thus, the mutual dependency between various image blocks in the same motion estimation region during motion estimation can be eliminated. As a result, parallel coding in the motion estimation region can be realized.

In some embodiments, determining the size of the motion estimation region of the image block to be processed includes, when the quadtree division node is an intermediate node of the quadtree, using the size of the quadtree division node as the size of the motion estimation region.

In some embodiments, when the division information of the quadtree division node indicates that the image block to be processed still needs to undergo quadtree division, the size of the quadtree division node is used as the size of the motion estimation region.

For example, the size of an intermediate node at a preset hierarchical depth of the quadtree is determined as the size of the motion estimation region. The preset hierarchical depth is known to the encoding end and the decoding end.

As another example, the size of an intermediate node on the quadtree with a size greater than or equal to a preset value is determined as the size of the motion estimation region. The preset value is known to the encoding end and the decoding end.

Therefore, in some embodiments of the disclosure, the size of the motion estimation region is set to be equal to the size of the intermediate node of the quadtree. Thus, the mutual dependency between various image blocks in the same motion estimation region during motion estimation can be eliminated. As a result, parallel coding in the motion estimation region can be realized.

In some embodiments, determining the size of the motion estimation region of the image block to be processed includes, when the size of the quadtree division node is greater than or equal to a reference size of the motion estimation region, using the reference size of the motion estimation region as the size of the motion estimate region.

In some embodiments, the division information of the quadtree division node indicates that the image block to be processed still needs to undergo quadtree division.

The reference size of the motion estimation can be configured, or can be specified through an agreement. For example, the reference size of the motion estimation region can be 16×16 pixels.

For example, division nodes of the quadtree of the image block to be processed are traversed. When the size of a division node (intermediate node or leaf node) is greater than or equal to the reference size of the motion estimation region, the size of the division node is determined as the size of the motion estimation region.

In some embodiments, determining the size of the motion estimation region of the image block to be processed includes, when the size of the quadtree division node is greater than or equal to the reference size of the motion estimation region, the division information of the quadtree division node indicates that the image block to be processed still needs to undergo quadtree division, and the size of the next level division node of the quadtree division node is smaller than the reference size of the motion estimation region, the reference size of the motion estimation region is taken as the size of the motion estimation region.

In the embodiments involving the reference size of the motion estimation region, the reference size of the motion estimation region can be fixed, such as being set in advance, or the reference size of the motion estimation region can vary in real time, such as changing according to specific needs.

For example, if it is reasonable for CTU1 to use a reference size of the motion estimation region of 16×16 pixels, then the MER size of CTU1 is determined according to the reference size of the motion estimation region of 16×16 pixels; and if it is reasonable for CTU2 to use a reference size of the motion estimation region of 32×32 pixels, then the size of the MER of CTU2 is determined according to the reference size of the motion estimation region of 32×32 pixels.

As described above, the method for determining the size of the motion estimation region is known to both the encoding end and the decoding end. In the embodiments in which the size of the motion estimation region is determined according to the reference size of the motion estimation region, the reference size of the motion estimation region is known to both the encoding end and the decoding end.

If the execution entity of the method 400 is an encoder, the motion information acquisition method 400 further includes encoding the reference size of the motion estimation region.

If the execution entity of the method 400 is a decoder, the motion information acquisition method 400 further includes decoding to obtain the reference size of the motion estimation region.

In some embodiments, when the reference size of the motion estimation region is involved, if the execution entity is the encoding end, the method further includes that the encoding end sends the reference size of the motion estimation region to the decoding end.

In some embodiments, when the reference size of the motion estimation region is involved, the reference size of the motion estimation region can be pre-configured at the encoding end and the decoding end, or the reference size of the motion estimation region can be specified through an agreement.

Therefore, in some embodiments of the disclosure, the size of the quadtree partition node is used as the size of the motion estimation region with referencing to the reference size of the motion estimation region. Thus, the mutual dependency between various image blocks in the same motion estimation region during motion estimation can be eliminated. As a result, parallel coding in the motion estimation region can be realized.

In some embodiments, determining the size of the motion estimation region of the image block to be processed includes, when a division depth of the quadtree division node on the quadtree is equal to a preset division depth, using the size of the division node of the quadtree as the size of the motion estimation region.

If the execution entity of the method 400 is an encoder, the motion information acquisition method 400 further includes encoding the preset division depth.

If the execution entity of the method 400 is a decoder, the motion information acquisition method 400 further includes decoding to obtain the preset division depth.

In some embodiments, the preset division depth can be pre-configured at the encoding end and the decoding end, or the preset division depth can be specified through a protocol.

In some embodiments, determining the size of the motion estimation region of the image block to be processed includes, when the number of encoding or decoding units included in the quadtree division node is greater than or equal to a preset coding number (preset encoding number or preset decoding number), using the size of the quadtree division node as the size of the motion estimation region.

When the execution entity of the method is an encoder, and when the number of encoding units included in the quadtree division node is greater than or equal to a preset encoding number, the size of the quadtree division node is taken as the size of the motion estimation region.

When the execution entity of the method is a decoder, and when the number of decoding units included in the quadtree division node is greater than or equal to a preset decoding number, the size of the quadtree division node is taken as the size of the motion estimation region.

In some embodiments, the division information of the quadtree division node indicates that the image block to be processed still needs to undergo quadtree division, and the number of the encoding or decoding units included in the division node at the next level of the quadtree division node is smaller than the preset encoding or decoding number.

If the execution entity of the method 400 is an encoder, the motion information acquisition method 400 further includes encoding the preset coding number.

If the execution entity of the method 400 is a decoder, the motion information acquisition method 400 further includes decoding to obtain the preset coding number.

In some embodiments, the preset coding number can be pre-configured at the encoding end and the decoding end, or the preset coding number can be specified through a protocol.

The various embodiments described herein may be independent solutions, or may be combined according to internal logic, and these solutions fall within the scope of the present disclosure.

Method embodiments of the present disclosure are described above, and the device embodiments of the present disclosure are described below. Descriptions of the device embodiments and the descriptions of the method embodiments correspond to each other. Thus, for any parts in the device embodiments that are not described in detail, reference can be made to the above method embodiments.

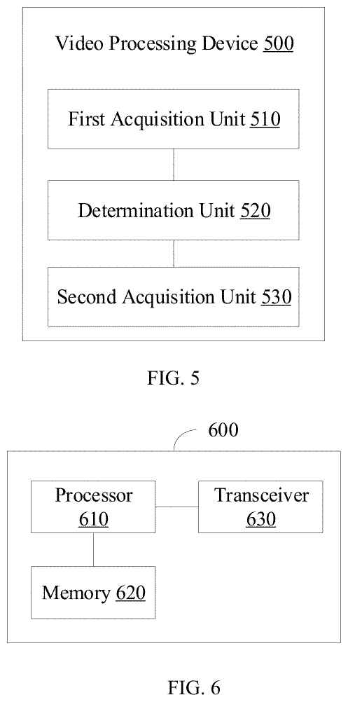

FIG. 5 is a schematic block diagram of a video processing device 500 consistent with the disclosure. The video processing device 500 can be used to implement a method consistent with the disclosure, such as one of the example methods described above. As shown in FIG. 5, the video processing device 500 includes a first acquisition unit 510, a determination unit 520, and a second acquisition unit 530. The first acquisition unit 510 is configured to obtain an image block to be processed. The image block to be processed is subject to quadtree division and non-quadtree division to obtain coding units. The determination unit 520 is configured to determine a motion estimation region of the image block to be processed according to division information and size of a quadtree division node of the image block to be processed. The second acquisition unit 530 is configured to obtain motion information of encoding units or decoding units in the motion estimation region according to the motion estimation region.

Therefore, according to the solutions provided by the disclosure, a motion estimation region is determined according to the division information and size of the quadtree division node, which includes determining the size of the motion estimation region according to the size of the quadtree division node. As such, the dependency between image blocks in the same motion estimation region during motion estimation can be eliminated, so that parallel encoding or decoding in the motion estimation region can be realized.

The video processing device 500 can be an encoding device, a decoding device, or a device with encoding and decoding functions.

In some embodiments, the determination unit 520 is configured to determine a size of the motion estimation region of the image block to be processed according to the division information and size of the quadtree division node.

In some embodiments, the determination unit 520 is configured to, when the quadtree division node is a leaf node of the quadtree, use the size of the quadtree division node as the size of the motion estimation region.

In some embodiments, the determination unit 520 is configured to, when the quadtree division node is the root node of a non-quadtree, use the size of the quadtree division node as the size of the motion estimation region.

In some embodiments, the determination unit 520 is configured to, when the quadtree division node is an intermediate node of the quadtree, use the size of the quadtree division node as the size of the motion estimation region.

In some embodiments, the determination unit 520 is configured to, when the division information of the quadtree division node indicates that the image block to be processed is no longer subject to quadtree division, use the size of the quadtree division node as the size of the motion estimation region.

In some embodiments, the determination unit 520 is configured to, when the size of the quadtree division node is greater than or equal to a reference size of the motion estimation region, use the reference size of the motion estimation region as the size of the motion estimate region.

In some embodiments, the division information of the quadtree division node indicates that the image block to be processed still needs to undergo quadtree division.

In some embodiments, on the quadtree of the image block to be processed, the size of the next level division node of the quadtree division node is smaller than the reference size of the motion estimation region.

In some embodiments, the video processing device 500 is an encoding device and further includes an encoding unit configured to encode the reference size of the motion estimation region.

In some embodiments, the video processing device 500 is a decoding device and further includes a decoding unit configured to decode to obtain the reference size of the motion estimation region.

In some embodiments, the determination unit 520 is configured to, when a division depth of the quadtree division node on the quadtree is equal to a preset division depth, use the size of the division node of the quadtree as the size of the motion estimation region.

In some embodiments, the video processing device 500 is an encoding device and further includes an encoding unit configured to encode the preset division depth.

In some embodiments, the video processing device 500 is a decoding device and further includes a decoding unit configured to decode to obtain the preset division depth.

In some embodiments, the determination unit 520 is configured to, when the number of encoding units or decoding units included in the quadtree division node is greater than or equal to a preset coding number, use the size of the quadtree division node as the size of the motion estimation region.

In some embodiments, the video processing device 500 is an encoding device and further includes an encoding unit configured to encode the preset coding number.

In some embodiments, the video processing device 500 is a decoding device and further includes a decoding unit configured to decode to obtain the preset coding number.

In some embodiments, the second acquisition unit 530 is configured to obtain the motion information of the encoding units or the decoding units in the motion estimation region according to motion information of encoding units or decoding units outside the motion estimation region.

In some embodiments, the second acquisition unit 530 is configured to obtain Merge list information of the encoding units or the decoding units in the motion estimation region according to motion information of encoding units or decoding units outside the motion estimation region.

In some embodiments, the image block to be processed is an image block to be encoded or an image block to be decoded.

Each of the first acquisition unit 510, the determination unit 520, and the second acquisition unit 530 can be implemented by a processor or a processor-related circuit.

FIG. 6 shows another example video processing device 600 consistent with the disclosure. The video processing device 600 includes a processor 610, a memory 620, and a transceiver 630. The memory 620 stores instructions or a program, and the processor 610 is configured to execute the instructions or program stored in the memory 620. When the instructions or program stored in the 620 is executed, the processor 610 is configured to perform a method consistent with the disclosure, such as one of the above-described example methods.

The video processing device 600 can be an encoding device, a decoding device, or a device with encoding and decoding functions.

Embodiments of the present disclosure also provides a chip. The chip includes a processor and a communication interface. The processor is configured to control the communication interface to communicate with an external device, and to perform a method consistent with the disclosure, such as one of the above-described example methods.

Embodiments of the present disclosure also provides a computer-readable storage medium, on which a computer program is stored. The computer program, when executed by a computer, causes the computer to perform a method consistent with the disclosure, such as one of the above-described example methods.

Embodiments of the present disclosure also provides a computer program product containing instructions. The instructions, when executed by a computer, cause the computer to perform a method consistent with embodiments of the disclosure.

An embodiment of the disclosure can be implemented in whole or in part by software, hardware, firmware, or any other combination. When being implemented by software, the embodiment can be implemented in the form of a computer program product in whole or in part. The computer program product includes one or more computer instructions. When the computer program instructions are loaded and executed on a computer, the processes or functions described in an embodiment of the present disclosure are implemented in whole or in part. The computer may be a general-purpose computer, a special-purpose computer, a computer network, or another programmable device. The computer instructions may be stored in a computer-readable storage medium, or transmitted from one computer-readable storage medium to another computer-readable storage medium. For example, the computer instructions may be transmitted from a website, computer, server, or data center to another website, computer, server, or data center via wired (such as coaxial cable, optical fiber, digital subscriber line (DSL)) or wireless (such as infrared, wireless, microwave, etc.) means. The computer-readable storage medium may be any available medium that can be accessed by a computer or a data storage device such as a server or data center integrated with one or more available media. The usable medium may be a magnetic medium (for example, a floppy disk, a hard disk, a magnetic tape), an optical medium (for example, a digital video disc (DVD)), or a semiconductor medium (for example, a solid state disk (SSD)), etc.

A person of ordinary skill in the art may realize that the units and algorithm steps in the examples described in combination with embodiments of the disclosure can be implemented by electronic hardware or a combination of computer software and electronic hardware. Whether a function is executed by hardware or software depends on the specific application and design constraint conditions of the technical solution. A person of ordinary skill in the art can use different methods for each specific application to implement the described functions, but such implementation should not be considered as beyond the scope of this disclosure.

The disclosed system, device, and method may be implemented in other manners. For example, the device embodiments described above are merely illustrative. For example, the division of units is only a logical function division, and there may be other divisions in actual implementation. For example, multiple units or components can be combined or can be integrated into another system, or some features can be ignored or not implemented. In addition, the displayed or discussed mutual coupling, direct coupling, or communication connection may be indirect coupling or communication connection through some interfaces, devices, or units, and may be in electrical, mechanical, or another form.

The units described as separate components may or may not be physically separated, and the components displayed as units may or may not be physical units, i.e., they may be located in one place, or they may be distributed on multiple network units. Some or all of the units may be selected according to actual needs to achieve the objectives of the solutions of the embodiments.

Further, functional units in each embodiment of the present disclosure may be integrated into one processing unit, or each unit may physically exist alone, or two or more units may be integrated into one unit.

The above are only specific implementations of this disclosure, but the scope of the disclosure is not limited to this. Any changes or substitutions within the technical scope of the disclosure that can be easily conceived by a person skilled in the art should be within the scope of the disclosure. The protection scope of this application should be subject to the protection scope of the claims.

What is claimed is:

1. A motion information acquisition method comprising:
acquiring a to-be-processed image block, the to-be-processed image block being divided into coding units using quadtree division and non-quadtree division;
determining a motion estimation region of the to-be-processed image block according to division information and size of quadtree division nodes of the to-be-processed image block; and
obtaining motion information of a coding unit or decoding unit in the motion estimation region according to the motion estimation region.
